(19) United States
(12) Patent Application Publication
(10) Pub. No.: US 2008/0183878 A1
(43) Pub. Date: Jul. 31, 2008

(54) System And Method For Dynamic Patching Of Network Applications

(76) Inventors: Sudip Kumar Panda, Bangalore (IN); Saurav Lahiri, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/021,846

(22) Filed: Jan. 29, 2008

(30) Foreign Application Priority Data
Jan. 31, 2007 (IN) 206/CHE/2007

(51) Int. Cl. G06F 15/16

(52) U.S. Cl. 709/228

(57) ABSTRACT

The present description provides a system and method for dynamic patching of the network applications. In one arrangement, the system and method pertain to check if the system being updated is busy. In case the network applications are not busy the original components of the network application may be replaces with the updated version. In case the network application is busy the software updater would update the network application by creating a temporary network ports corresponding to the services in use and then replacing the older version with the updated version.

### RELATED APPLICATIONS

This patent application claims priority to Indian patent application serial no. 206/CHE/2007, titled “A System and Method for Dynamic Patching of Network Applications”, filed in India on 31 Jan. 2007, commonly assigned herewith, and hereby incorporated by reference.

### BACKGROUND

In a conventional client/server network infrastructure, a distributed computer network application is often set up to have at least one server node and multiple client nodes. The clients can access the server node over the network and request for services from the server. Patches or updates may be available for the server node from time to time. The patches could incorporate new features or could contain critical security fixes or fixes for critical errors for instance.

Network applications may require immediate patching when they are vulnerable for security or scheduled patching for normal application engineering fixes. In either case this generally requires a scheduled or unscheduled (based on the urgency with which the fix has to be applied) downtime of the application. However some applications and operating systems are mission-critical. This means that they must be available, or online, for use at all times. In such cases it can be difficult to replace or patch the software components when it becomes necessary.

### BRIEF DESCRIPTION OF THE DRAWINGS

Embodiments of the invention will now be described, by way of example only, with reference to the accompanying drawings in which elements having the same reference numeral designations represent like elements throughout and in which:

FIG. 1 is a schematic diagram illustrating a computer network;

FIG. 2 is a flow diagram illustrating the steps involved in updating a network application;

FIG. 3 is a flow diagram illustrating the steps involved in updating of the network application.

FIGS. 4a and 4b are flow diagrams illustrating steps taken at the transport layer of the network system at the time of dynamic patching of the network applications.

### DETAILED DESCRIPTION OF EMBODIMENTS OF THE INVENTION

In the following description, for the purpose of explanation, numerous specific details are set forth in order to provide a thorough understanding of the embodiments. It will be apparent, however, that the embodiments may be practiced without these specific details. In other instances, well-known structures and systems are schematically shown in order to simplify the drawing.

The flow diagrams included herein do not necessarily represent an execution in a single patching event, but rather, in some instances, may represent a sequence of coordinated steps, events, or processes occurring in a plurality of patching of network applications. In addition, the flow diagrams herein should not be interpreted as implying that no other events, steps, or processes can occur between those explicitly represented in the drawings.

As used herein the term “stale services” refers to the services being provided by an older version of a network application. Similarly, the term “updated services” will be used to refer to the services being provided by an updated version of the network application.

As used here in description the term “Org-Port” will be used to refer to the original port number used by the network application providing the stale services before the start of patching. Similarly the temporary port number that is assigned to the stale services in the manner to be described below will be referred to as “Temp-Port”.

The term “busy” will be used to refer to the fact that the network application has connection open or is otherwise being used. The network application may also be rated as busy if some of the components of the application are loaded in the memory of the computer system for processing the user's request.

The terms “updating” and “patching” will be used interchangeably.

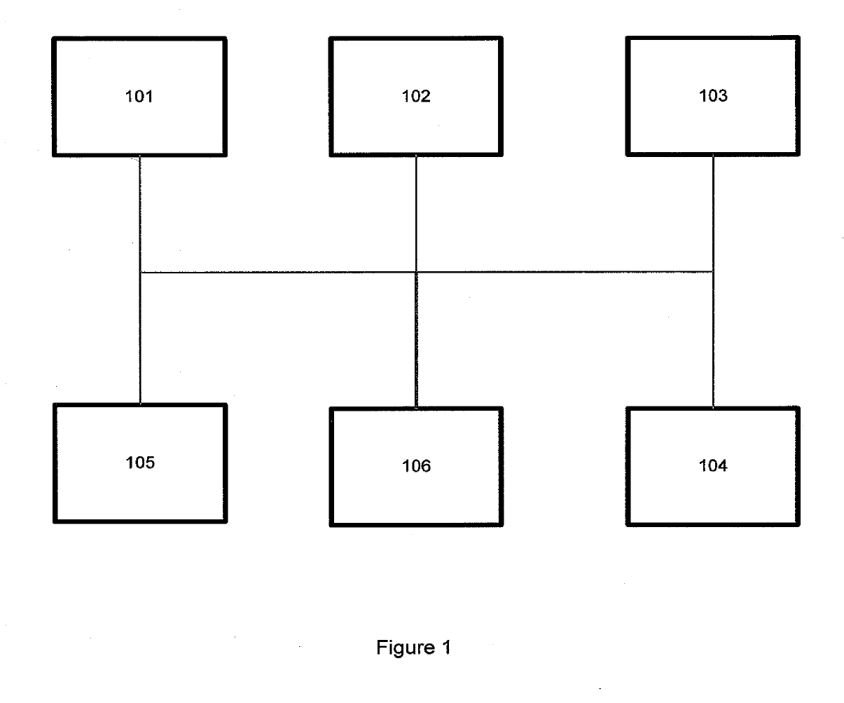

FIG. 1 illustrates a computer network system, as an example, which may typically, but not necessarily, be an intranet of a commercial organization, for instance, or the public internet, and has a plurality of user computing entities—including a server entity 106 and one or more client entities 101-105. Each of the entities 101-106 has a network address, in this example an Internet Protocol address.

As will be well understood, in such a computer network system, a transport layer provides transparent transfer of data between hosts and users or clients. The transport layer is usually responsible for end-to-end error recovery and flow control, and ensuring complete data transfer in a computer network. In the Internet Protocol suite this function is most commonly achieved by the connection-oriented transmission control protocol (TCP) or a datagram-type transport, user datagram protocol (UDP), although UDP provides neither error recovery, nor flow control, leaving these to the application layer if they are needed.

In the system to be described below, if there are clients and/or users connected to network applications that are to be updated, a software update function moves the stale services to a temporary port number. In this way, the existing client requests may continue to be serviced by the old version of the network application and the components of the older version of the network application are not deleted immediately to avoid interrupting network services being provided by the system. Using the techniques to be described, the older version of the network application continues servicing the requests sent from the client and/or users, which were initiated prior to the start of the process of updating of the network application. The functionality that serves to move the network applications to different ports may be implemented in a port switcher module within the transport layer which operates under the control of an application layer software updater module.

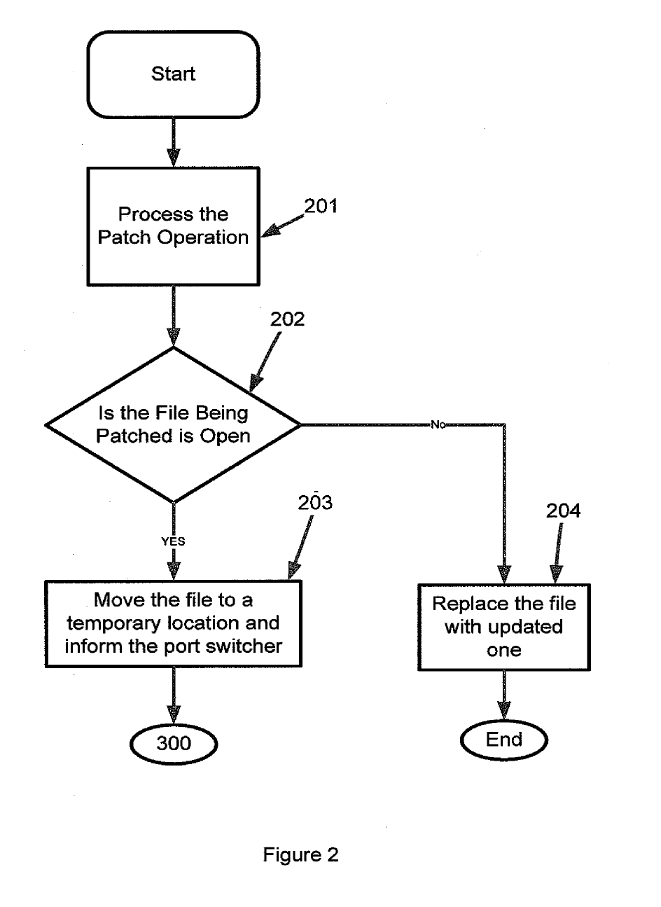

Referring now to FIG. 2, the initial steps involved in the method for dynamic patching of the network application in a computer network system will be described.

As illustrated in FIG. 2, the method comprises processing the update operation 201 which may include determining the location of the various components of the network application. A network application may comprise of configuration files, shared libraries, archive libraries and other executables.

In step 202, it is determined if any of the files of the network application to be updated are open i.e. if the network application is processing a client request. If the network application is servicing and/or processing client requests, the application is classified as busy.

It may be verified if the network application is busy in various ways, for instance by checking if any components of the network application are loaded in the memory device of the computer system by making a query to the process table which keeps a record of the resources which have been allocated to the processes running on the processor in the computer system. The software updater component may determine if the network application to be patched is busy by checking if there are clients connected to the network application. The software updater may also determine if a software application is busy also by checking if the any components of the older version i.e. all of the shared libraries (dynamically linked libraries), executables are open.

In step 202, if none of the files of the network application classified as busy, the old version of the network application may simply be replaced with the updated version at the original location—step 204—and restarted.

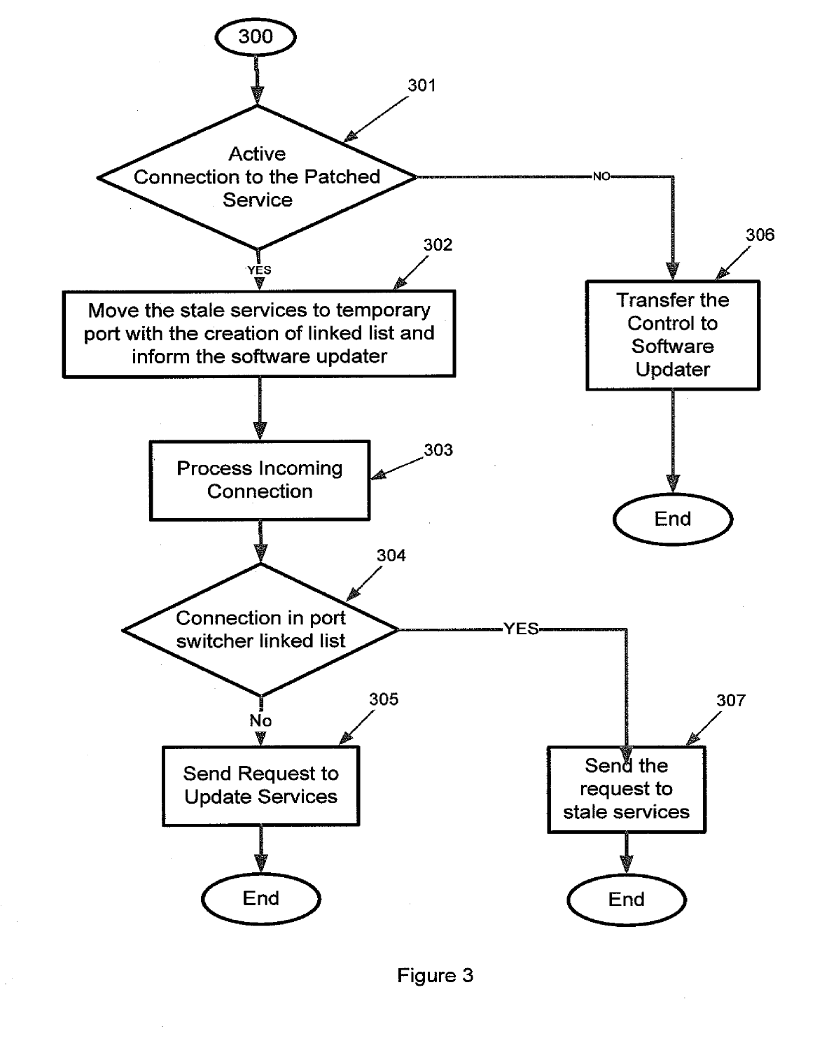

Referring now to FIG. 3, a method for dynamic patching of network applications which are classified as busy, i.e. where there are active connections to the network application to be patched, in step 202 will be described.

In this case in step 302 a new temporary port number is created by the transport layer and the original version of the network application is moved to the newly created temporary port number. A list is created containing the source address, source port, destination address and destination port for the active connections in the original version of the network application. This list may be created in the form of a suitable data structure such as a linked list, for instance.

The updated application is then installed by the software updated application and started so that it listens on the same port previously assigned to the network application.

In step 303, the incoming packets at the transport layer for the network application are checked for the source IP address and source port number before being sent for processing. If the source IP address and source port of the received packets do not correspond to a source IP address—source port number pair stored in the list, the packet is sent to the updated network application for processing. If the source IP address and the source port number of the incoming request packets correspond to one of the source address—source port number pairs contained in the list; the request packets are redirected to the original network application by changing the source port number for the packet to the temporary port.

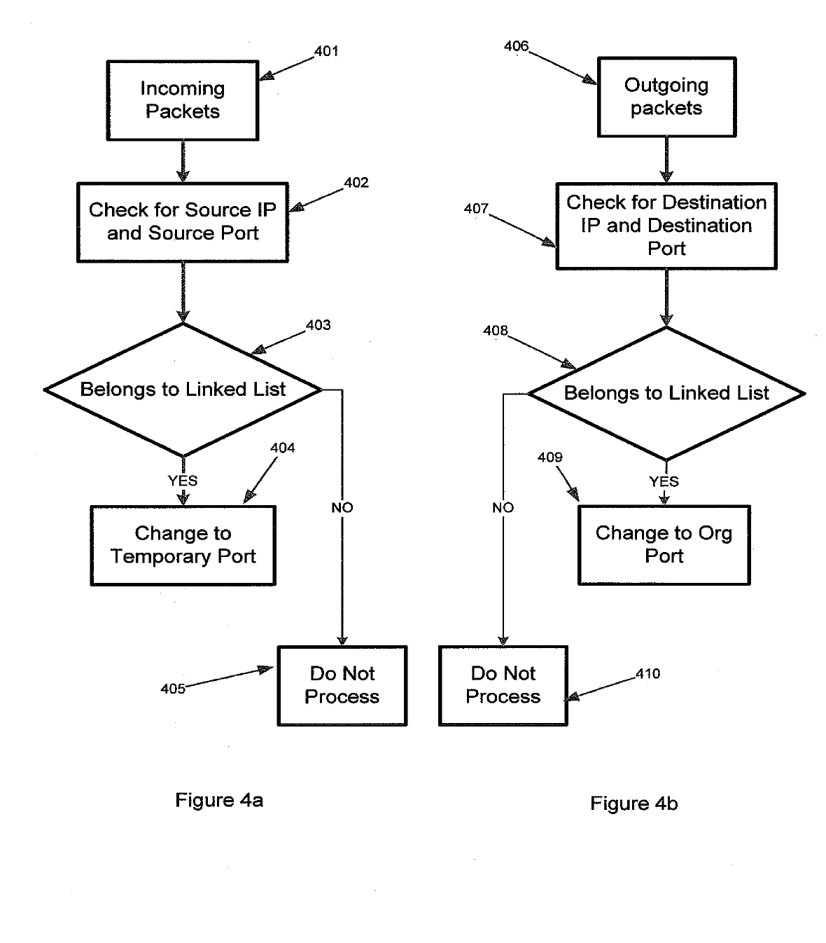

FIG. 4 illustrates the steps involved at the transport layer in the processing of the incoming requests packets to the network application as well as outgoing packets from the network application in response to a client/user query during the period of the patching of the network application. As illustrated in FIG. 4, when a user sends a request for the network services, a request packet is received 401 at the transport layer of the network system. The port switcher module checks the received packet for the source IP address and the source port number 402. If the source IP address and the source port number of the received packet belong to connections present on the list created by the port switcher 403, the destination port is changed to “Temp-Port” number 404. This enables the network system to send the packet to the original version of the network application, where it may be processed.

Referring to FIG. 4b, where the network application is sending a response to the user requests 406, the port switcher module at the transport layer of the network system checks the packet for the destination IP address and the destination port number 407. If the destination IP address and the destination port number belongs to connections present on the linked list 408 then the source port number in the outgoing packet is changed from “Temp-Port” to “Org-Port” 409. Hence, the movement of the port is transparent to the clients while the upgrade is being performed on the network applications.

The software updater determines if the old requests from the user and or clients have been satisfied or not and then closes the connections after sending any necessary responses to the client and/or user requests. The port switcher module in the transport layer may that remove the corresponding elements from the list.

When the list contains no further elements the original instance of the network application may be stopped and any files no longer needed may be deleted.

In this way, the dynamic patching of the network applications may be performed without the requirement to restore state and ensuring application and/or system continuity.

The techniques described above may be embodied in a computer-readable medium for configuring a computer system to execute the method. The computer readable media may be permanently, removably or remotely coupled to system or another system. The computer readable media may include, for example and without limitation, any number of the following: magnetic storage media including disk and tape storage media; optical storage media such as compact disk media and digital video disk storage media; holographic memory; nonvolatile memory storage media; ferromagnetic digital memories; volatile storage media including registers, buffers or caches, main memory, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computer systems may be found in many forms including but not limited to mainframes, minicomputers, servers, workstations, personal computers, notepads, personal digital assistants, various wireless devices and embedded systems, just to name a few. A typical computer system includes at least one processing unit, associated memory and a number of input/output (I/O) devices. A computer system processes information according to a program and produces resultant output information via I/O devices.

It is to be understood that the algorithm depicted herein are merely exemplary, and that in fact many other algorithms can be implemented which achieve the same functionality by a person with ordinary skill in the art. The applications referred to herein may be modules or portions of modules (e.g., software, firmware, or hardware modules). For example, the network applications discussed herein may include script, batch or other executable files, or combinations and/or portions of such files. The network applications may include a computer program or subroutines thereof encoded on computer-readable media.

A program is a list of instructions such as a particular application program and/or an operating system. A computer program is typically stored internally on computer readable storage media or transmitted to the computer system via a computer readable transmission medium. A computer process typically includes an executing (running) program or portion of a program, current program values and state information, and the resources used by the operating system to manage the execution of the process. A parent computer process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Additionally, those skilled in the art will recognize that the boundaries between modules are merely illustrative and alternative embodiments may merge modules or impose an alternative decomposition of functionality of modules. For example, the modules discussed herein may be decomposed into sub-modules to be executed as multiple computer processes. Moreover, alternative embodiments may combine multiple instances of a particular module or sub-module. Furthermore, those skilled in the art will recognize that the operations described in exemplary embodiments are for illustration only. Operations may be combined or the functionality of the operations may be distributed in additional operations in accordance with the invention.

Realizations in accordance with the present technique have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

The exemplary embodiments are described in terms of computer programs, although it will be recognized that this is only one means for implementing the method of the invention. For example, some or all portions of the functionality described herein could be implemented in hardware if desired.

1. A method for updating a network application listening on a first port, comprising the steps of:
moving the network application to a second temporary port;
creating a list of connections moved to the second temporary port;
redirecting packets on the listed connections to the temporary port; and
configuring an updated network application to listen at the first port.

2. A method as claimed in claim 1 comprising determining if the network application is busy and, if so, carrying out the steps of claim 1.

3. A method as claimed in claim 2 wherein the network application is determined as busy if any of the components of the network application is loaded in the memory of the computer system.

4. A method as claimed in claim 2 wherein the network applications is determined as busy if there are clients having a connection with the network application.

5. A method as claimed in claim 1 wherein a node in the list of connections comprises for each connection in the list a source internet protocol address, source port number, destination internet protocol address and destination port number.

6. A method as claimed in claim 1 comprising checking the source internet protocol address and/or source port number of incoming packets and changing the port address to the temporary port number if they correspond to a connection present on the list.

7. A method as claimed in claim 1 comprising for outgoing packets checking the destination internet protocol address and destination port number for the response to the client or user requests and changing them to original port number if they belong to connections present on the list.

8. A method as claimed in claim 1 comprising removing the elements from the list when the corresponding connections are closed.

9. A server having an arrangement for updating a network application listening on a first port, the arrangement a port switcher for:
moving the network application to a second temporary port;
creating a list of connections moved to the second temporary port;
redirecting packets on the listed connections to the temporary port; and
configuring an updated network application to listen at the first port.

10. A server as claimed in claim 9 wherein the port switcher determines if the network application is busy and, if so, carrying out the steps of claim 1.

11. A server as claimed in claim 10 wherein the network application is determined as busy if any of the components of the network application is loaded in the memory of the computer system.

12. A server as claimed in claim 10 wherein the network applications is determined as busy if there are clients having a connection with the network application.

13. A server as claimed in claim 9 wherein a node in the list of connections comprises for each connection in the list a source internet protocol address, source port number, destination internet protocol address and destination port number.

14. A server as claimed in claim 9 wherein, whilst a network application is being updated, the port switcher checks the source internet protocol address and/or source port number of incoming packets and changes the port address to the temporary port number if they correspond to a connection present on the list.

15. A server as claimed in claim 9 wherein, whilst a network application is being updated, the port switcher checks the destination internet protocol address and destination port number for the response to the client for outgoing packets and changes the destination port address to the original port number if they belong to connections present on the list.

16. A server as claimed in claim 9 wherein the port switcher removes the elements from the list when the corresponding connections are closed.

17. A server as claimed in claim 9 wherein the port switcher is implemented in a transport layer.
